(19) United States
(12) Patent Application Publication
(10) Pub. No.: US 2012/0115021 A1
(43) Pub. Date: May 10, 2012

(54) BATTERY AND BATTERY MANUFACTURING APPARATUS

(75) Inventor: Hiroaki Yotsumoto, Tokyo (JP)

(73) Assignee: MITSUBISHI HEAVY INDUSTRIES, LTD., Tokyo (JP)

(21) Appl. No.: 13/285,521

(22) Filed: Oct. 31, 2011

(30) Foreign Application Priority Data
Nov. 5, 2010 (JP) 2010-248824

(51) Int. Cl. H01M 2/30; H01M 10/04; H01M 4/04

(52) U.S. Cl. 429/178; 29/730

(57) ABSTRACT

A battery includes: an electrode terminal that includes a fastening member; and an electrode plate that includes an electrode tab provided with a through-hole. The through-hole is a part of an outer shape of the electrode plate, and the electrode terminal and the electrode plate are electrically connected to each other through the through-hole by the fastening member.

### BACKGROUND OF THE INVENTION

1. Field of the Invention

The present invention relates to a battery including a stacked electrode body and a manufacturing apparatus thereof.

Priority is claimed on Japanese Patent Application No. 2010-248824, filed on Nov. 5, 2010, the content of which is incorporated herein by reference.

2. Description of Related Art

Batteries are used in various electric systems such as an electric vehicle, a stationary power supply apparatus, and a power generating apparatus. Among the batteries, there are typically two types of batteries having a structure in which electrode plates (a positive electrode plate and a negative electrode plate) are stacked with a separator interposed between them (hereinafter, referred as a stacked electrode body), which are a winding-type battery and a stacked-type battery. The winding-type battery has a structure of which a stacked electrode body consists of one sheet-like positive electrode plate, one sheet-like negative electrode plate, and are a separator interposed between them. The stacked electrode body of the winding-type battery is rolled up and is stored in a battery case. The stacked-type battery has a structure of a stacked electrode body consists of a plurality of sheet-like positive electrode plates, a plurality of sheet-like negative electrode plates each of that is stacked on each of the positive electrode plates respectively, and separators each of that are interposed between one of the positive electrode plates and the adjacent one of the negative electrode plates respectively. The stacked electrode body of the stacked-type battery is not rolled up and is stored in a battery case.

As an example of the battery, for example, there is the stacked-type secondary battery disclosed in Japanese Patent Application Laid-Open No. 2005-5215. The secondary battery has a structure including a stacked electrode body and an electrolyte, both of that are stored in a square battery case, and which is sealed by a battery cover. Each of the electrode plates has an electrode tab respectively. A bundle of the electrode tabs for the positive electrode plates and a bundle of the negative electrode plates are connected to one end of a corresponding lead among a plurality of stripe-shaped leads by ultrasonic-welding, and the other end of the lead is connected to a corresponding electrode terminal between a positive electrode terminal and a negative electrode terminal by a fastening member such as a rivet.

In recent years, it has been attempted to reduce an electrical resistance by removing the lead and by directly bonding the electrode tab to the electrode terminal. Here, as to the lead disclosed in Japanese Patent Application Laid-Open No. 2005-5215, a through-hole for inserting a fastening member such as a rivet thereinto is formed by a process different from a process of cutting out the electrode plate (hereinafter, referred as an electrode plate punching-out process). Accordingly, in the same manner, it may be considered that the through-hole is formed in the electrode tab by a process different from the electrode plate punching-out process. However, because the outer shape of the electrode plate is formed in the electrode plate punching-out process, the number of processes for making the battery may be decreased, and the productivity for making the battery may be improved in a case that the through-hole is simultaneously formed in the electrode tab at the same process.

However, when a mold having a blade for cutting out the electrode plate further includes a blade which has substantially the same shape as the cross-sectional shape of the fastening member and which forms the through-hole in the electrode tab, and when the mold is used for simultaneously cutting or punching out both of the electrode plate and the through-hole, wastes from the through-hole may fly in the factory and may not be appropriately collected during the electrode plate punching-out process. Therefore, the waste may slip into the battery case and may cause abnormalities in the performance of the battery.

That is, when the through-hole is simultaneously formed at the electrode plate punching-out process, the performance of the battery may be degraded. On the other hand, when the through-hole is formed with a different process from the electrode plate punching-out process, the improvement of the productivity is hindered. Thus, there is a relationship that both advantages are difficult to be obtained at the same time, because one needs to be sacrificed when the other is pursued.

### SUMMARY OF THE INVENTION

The invention is made in view of such circumstances, and it is an object of the invention to provide a battery having a structure for attaining a satisfactory battery performance and for improving productivity, and a manufacturing apparatus for making the battery.

According to an aspect of the invention, a battery includes: an electrode terminal including a fastening member; and an electrode plate including an electrode tab having a through-hole, wherein the through-hole is a part of an outer shape of the electrode plate, and the electrode terminal and the electrode plate are electrically connected through the through-hole by the fastening member.

Further, according to another aspect of the invention, a battery manufacturing apparatus for forming the battery includes: a mold for cutting the electrode plate; and a driving section driving the mold, wherein the driving section drives the mold to cut the electrode plate from an original sheet.

Because the through-hole formed in the electrode tab is formed as a part of the outer shape of the electrode plate, that is, the outer shape of the electrode plate is drawn by a continuous line together with including the through-hole, the through-hole is formed at the same time when the electrode plate is cut by the mold having the same shape of the electrode plate. Further, a waste is prevented from flying and dispersing. That is, degradation of the performance of the battery is prevented, and a process of forming the through-hole may be performed at the same time when the electrode plate is cut and punched out.

According to the aspect of the invention, it is possible to provide a battery improving productivity and having an excellent battery performance and a manufacturing apparatus thereof.

### BRIEF DESCRIPTION OF THE DRAWINGS

FIG. 1 illustrates a battery according to a first embodiment.

FIG. 2 illustrates a cross-sectional view with taken along the line A-A′ of the battery according to the first embodiment.

FIG. 3 illustrates a plan view of a positive electrode plate and a negative electrode plate of the battery according to the first embodiment.

FIG. 4 illustrates a side view of a battery manufacturing apparatus for manufacturing the battery.

FIG. 5 illustrates a visible perspective view of a part of the battery manufacturing apparatus, which is seen from the downside thereof.

FIG. 6 illustrates an upper part of the battery manufacturing apparatus.

FIG. 7 illustrates a mold used in the battery manufacturing apparatus of FIG. 4.

FIG. 8 illustrates a plan view around a through-hole punched out of an electrode tab according to a first modified example.

FIG. 9 illustrates a plan view around a through-hole punched out of an electrode tab according to a second modified example.

FIG. 10 illustrates a plan view around a through-hole punched out of an electrode tab according to a third modified example.

FIG. 11 illustrates a plan view around a through-hole punched out of an electrode tab according to a fourth modified example.

FIG. 12 illustrates stacked positive electrode plates of a battery according to a second embodiment.

### DETAILED DESCRIPTION OF THE INVENTION

Hereinafter, embodiments according to the invention will be described by referring to the drawings. The same reference numerals are given to the same components of the embodiment, and the description thereof will not be repeated.

### First Embodiment

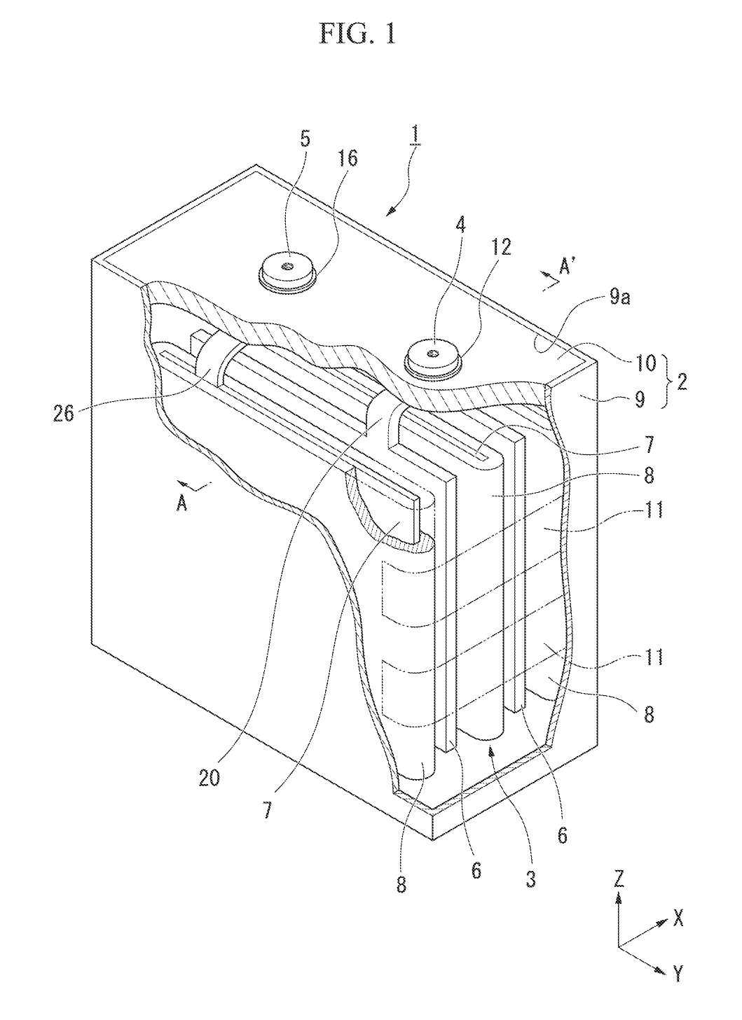

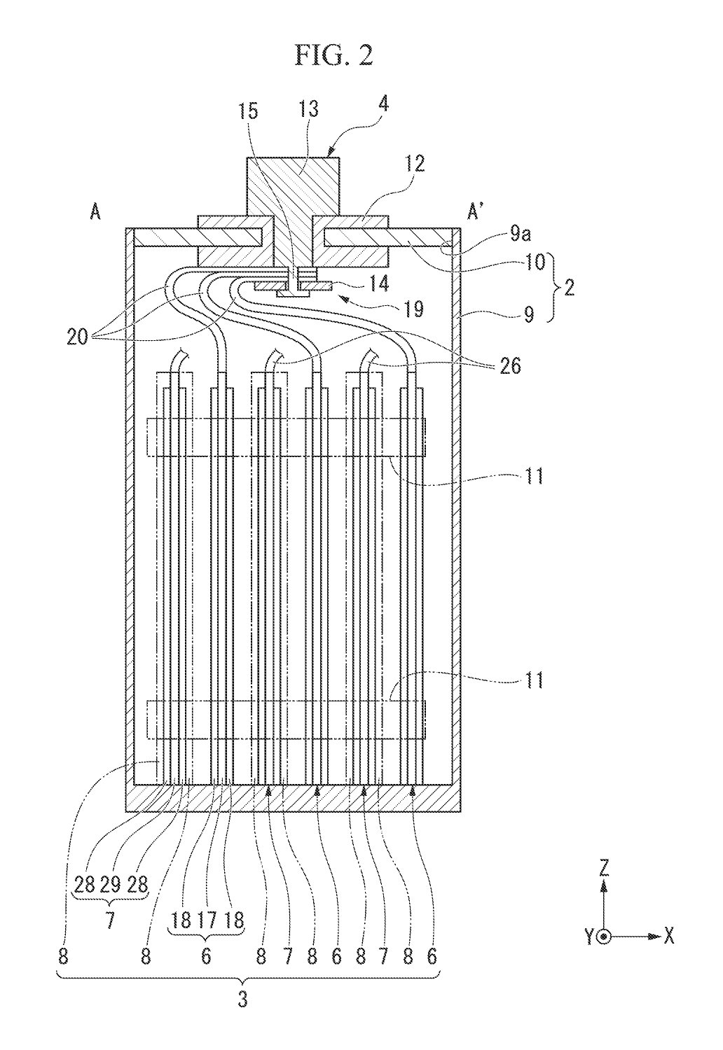

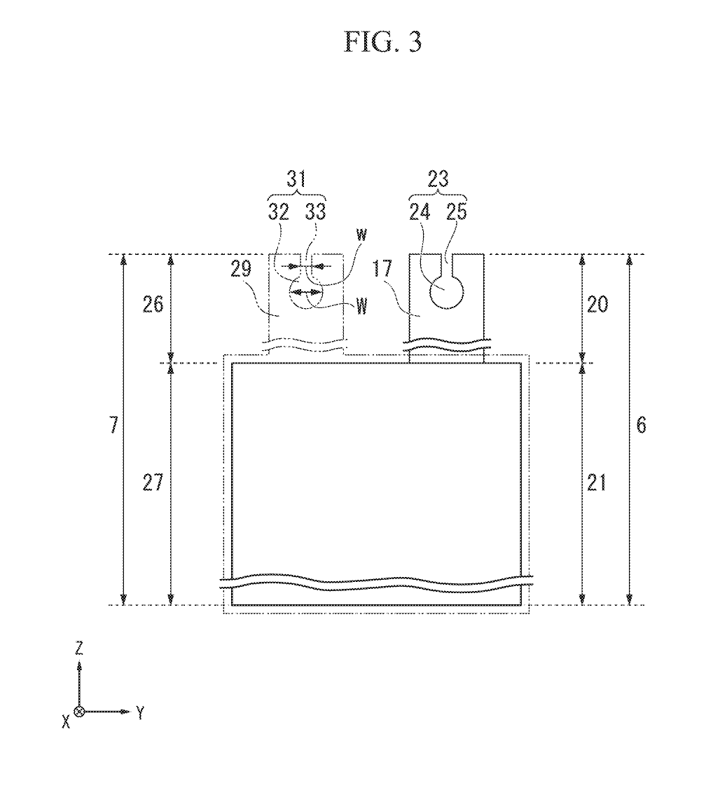

FIG. 1 illustrates a battery, FIG. 2 illustrates a cross-sectional view with taken along the line A-A′ of FIG. 1, and FIG. 3 illustrates a plan view of a positive electrode plate and a negative electrode plate used in the battery. A battery 1 illustrated in FIGS. 1 and 2 is a battery arranged in the XYZ orthogonal coordinate system (the same coordinate system is used in FIGS. 1 to 3), and is, for example, a lithium ion secondary battery.

The battery 1 has a structure that an opening 9a of a substantially square case body 9, from which a stacked electrode body 3 is stored, is sealed with a battery cover 10. The battery cover 10 includes electrode terminals that are a positive electrode terminal 4 and a negative electrode terminal 5. Hereinafter, a structure that the case body 9 is sealed by the battery cover 10 is called as a battery case 2. Here, the battery case 2 is arranged at a position that the long side of the bottom surface of the case body 9 is set on the Y direction, that the short side of the bottom surface is set on the X direction, and that the height direction of the case body 9 is set on the Z direction.

Both ends of the electrode terminals respectively come out from both surfaces of the battery cover 10 through through-holes (not illustrated) provided in the battery cover 10. And the electrode terminals are fixed to the battery cover 10 as one body by an insulating resins without electrically connecting each other. The insulating resin near the positive electrode terminal 4 is denoted by the reference numeral 12, and the insulating resin near the negative electrode terminal 5 is denoted by the reference numeral 16. The battery case 2 stores an electrolyte (not illustrated).

The stacked electrode body 3 has a structure that electrode plates (i.e., a positive electrode plate 6 or a negative electrode plate 7), each of that has a corresponding electrode tab (i.e., a positive electrode tab or a negative electrode tab), are stacked with a separator 8 interposed between them. Here, an example of the stacked electrode body 3 is illustrated that a plurality of positive electrode plates 6 having positive electrode tabs 20 and a plurality of negative electrode plates 7 having negative electrode tabs 26 are alternately stacked through the separators 8, and that the stacked electrode plates are fixed to be as one body by a fixation member 11 such as an insulation tape. Each of the separators 8 is put between one of the positive electrode plates 6 and the adjacent one of the negative electrode plates 7 respectively. Then, a bundle of the positive electrode tabs 20 are electrically connected to the positive electrode terminal 4. And in the same manner, a bundle of the negative electrode tabs 26 are electrically connected to the negative electrode terminal 5.

The cross-section on the ZX plane with taken along the line A-A′ of FIG. 1 is illustrated in FIG. 2. A structure of the positive electrode plate 6 is that a positive electrode active material 18 such as lithium magnate is coated on both surfaces of a current collector 17 formed of metal such as aluminum. Further, a structure of the negative electrode plate 7 is that a negative electrode active material 28 such as carbon is coated on both surfaces of a current collector 29 formed of metal such as copper. Here, the current collector 17 and the positive electrode tab 20 are the same metal, and are integrally formed as one body (refer to FIG. 3). In the same manner, the current collector 29 and the negative electrode tab 26 are the same metal, and are integrally formed as one body (refer to FIG. 3).

Further, as illustrated in FIG. 2, the electrode terminal includes a fastening member 15, that is inserted into a through-hole (to be described later) of the electrode tab so as to fix the electrode tab to the electrode terminal, and a terminal body 13 in addition to the fastening member 15. The fastening member 15 may be a screw, a rivet, or the like. The fastening member 15 may be formed with the terminal body 13 as one body by the integral molding method, or they may be formed as separate parts and be connected with each other by bonding or the like.

In FIG. 2, as the fastening member 15, a rivet integrally formed with the electrode terminal as the one body is illustrated.

After a bundle of the plurality of positive electrode tabs 20 are inserted into the rivet, and after an auxiliary fastening member 14 such as a washer is inserted into the rivet, the end of the rivet is pressed to form a rivet head portion 19. Therefore, the positive electrode tab 20 is fixed to the positive electrode terminal 4 tightly.

Next, the electrode tab of the electrode plate of the battery 1 is described in detail by referring to FIG. 3.

FIG. 3 illustrates the positive electrode plates 6 and the negative electrode plates 7 that are stacked on each other (for convenience of description, the separator 8 is not illustrated). Here, the positive electrode plate 6 is depicted by the solid line, and the negative electrode plate 7 is depicted by the two-dotted chain line. The positive electrode plate 6 includes a substantially rectangular positive electrode tab 20 and a substantially rectangular positive electrode body 21. And the negative electrode plate 7 includes a substantially rectangular negative electrode tab 26 and a substantially rectangular negative electrode body 27.

The positive electrode active material is coated on the positive electrode body 21, and the negative electrode active material is coated on the negative electrode body 27. Then, when they are seen from the X direction, the positive electrode body 21 is arranged within the surface of the negative electrode body 27. That is, the positive electrode body 21 is designed to be smaller than the negative electrode body 27. Further, although the positive electrode tab 20 and the negative electrode tab 26 are arranged at substantially the same position on the Z axis, they are designed to be arranged at different positions on the Y axis respectively. Therefore, when they are stacked, the positive electrode tab 20 and the negative electrode tab 26 do not overlap each other or do not overlap completely.

The electrode tab (i.e., the positive electrode tab 20 or the negative electrode tab 26) has a through-hole (i.e., a through-hole 23 or a through-hole 31) which passes through the electrode tab from the front side to the rear side of the electrode tab when the electrode tab is seen in the YZ plane and which forms a part of an outer shape of the electrode plate (i.e., the positive electrode plate 6 or the negative electrode plate 7) having the electrode tab in the YZ plane. Specifically, the through-hole includes a through-hole body, that has substantially the same shape as the cross-sectional shape of the fastening member on the XY plane, and a slit, that is continuous from the outside of the electrode plate to the through-hole body. Accordingly, the outer shape of the electrode plate arranged on the YZ plane is able to be drawn with a single stroke although the through-hole body and the slit are drawn together.

Here, because the fastening member of the electrode terminal is, for example, a rivet which has a substantially cylindrical shape in the positive electrode terminal 4 and the negative electrode terminal 5, a through-hole body 24 of the positive electrode plate 6 and a through-hole body 32 of the negative electrode plate 7 are both formed to have substantially the same area and shape (here, a substantially circular shape) as those of the cross-section of the XY plane of the fastening member. Further, a slit 25 of the positive electrode tab 20 and a slit 33 of the negative electrode tab 26 are formed in the same shape in the Z direction.

As described above, because the electrode tab has the slit, there is an advantage, that the fastening member of the electrode terminal is easily inserted into the through-hole body, during manufacturing the battery. Further, although there are other manufacturing advantages, these will be described later.

Furthermore, as compared the maximum width “W” of the through-hole body in the Y direction with the maximum width “w” of the portion of the slit continuous to the through-hole body in the Y direction, it is designed that “W” is larger than “w” (i.e., the relationship of W>w is satisfied). Accordingly, since the electrode tab fixed to the fastening member 15 in the electrode terminal is not easily separated from the fastening member 15, there are structural advantages that the failure of the battery may be prevented and that the performance of the battery 1 may be improved, as well as the manufacturing advantage.

Then, the other manufacturing advantages will be described below in detail. In order to describe the advantages, a battery manufacturing apparatus 100 will be described as a battery manufacturing apparatus. The battery manufacturing apparatus 100 is a apparatus that punches out the substantially rectangular electrode plate (i.e., the positive electrode plate 6 or the negative electrode plate 7) from a sheet-like original sheet. The original sheet has a structure that an electrode active material is coated on both surfaces of a rectangular sheet-like current collector made of metal, and which has a length for forming a plurality of electrode plates by punching or cutting.

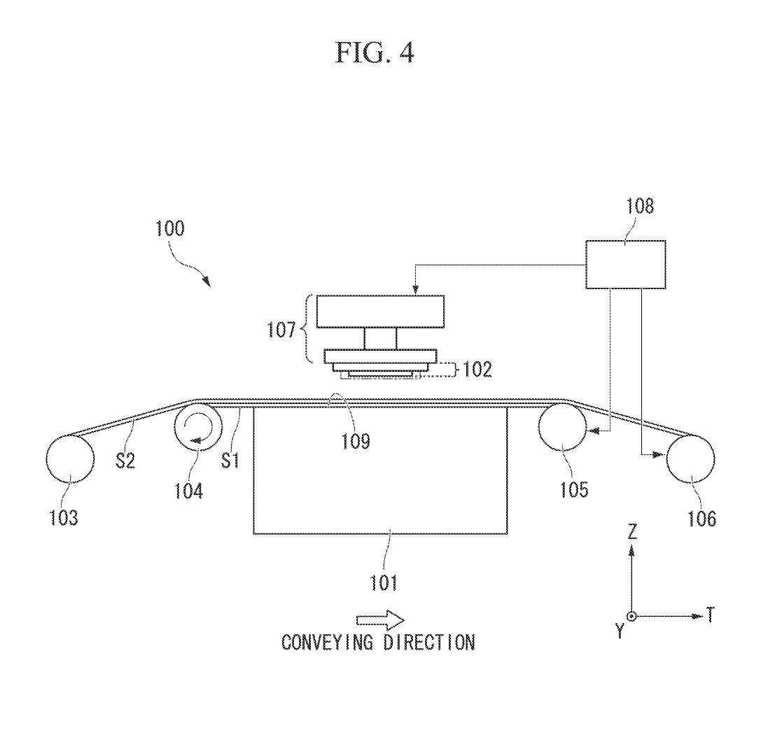

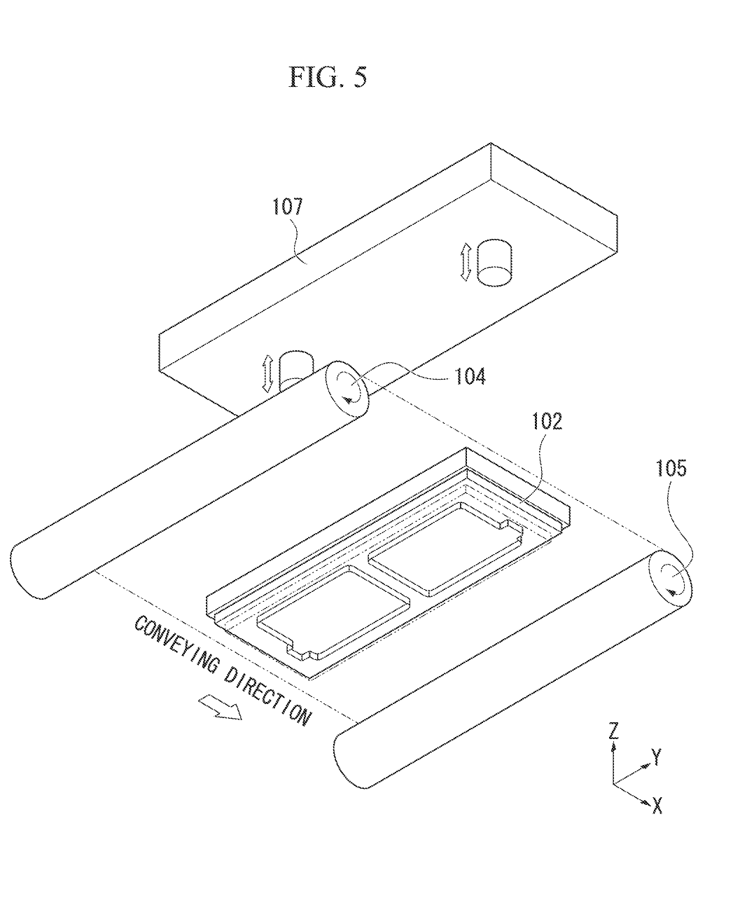

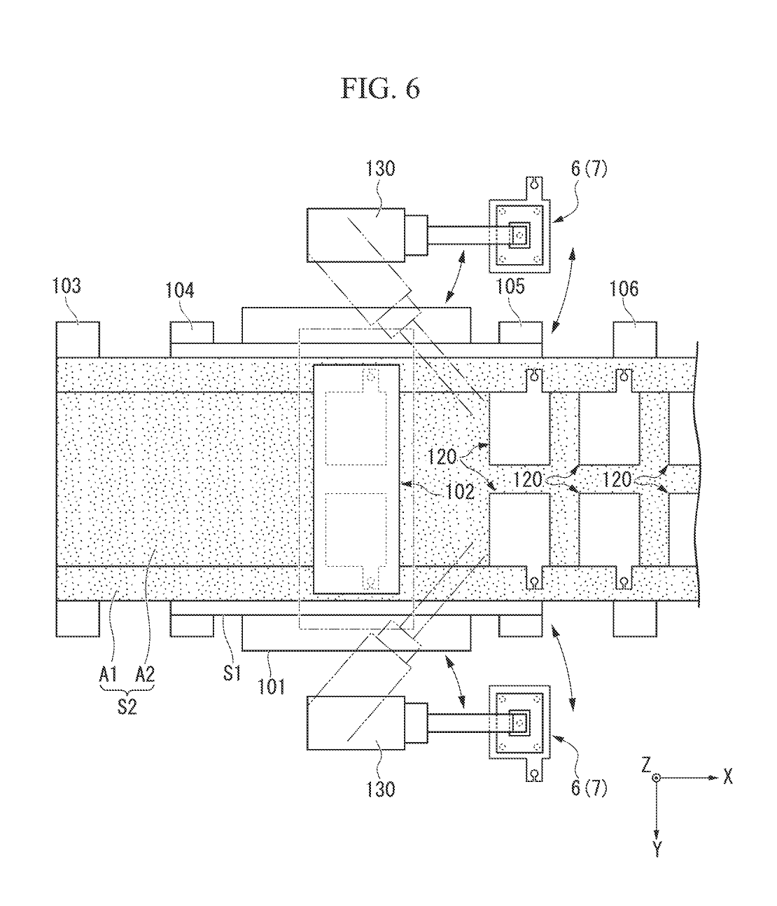

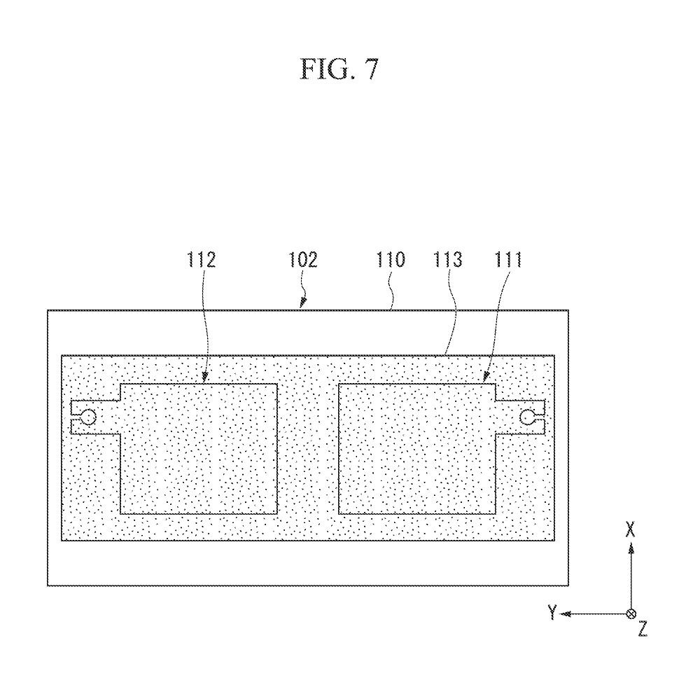

FIG. 4 illustrates a side view (XZ plan view) of the battery manufacturing apparatus 100. FIG. 5 illustrates a visible perspective view of a part of the battery manufacturing apparatus 100, when it is seen in the Z direction from an original sheet support portion 101, in order to describe the movement about punching out the electrode plate in the battery manufacturing apparatus 100. FIG. 6 illustrates a plan view (XY plan view) of the battery manufacturing apparatus 100. FIG. 7 illustrates a shape of a mold 102 used in the battery manufacturing apparatus 100 of FIG. 4. Furthermore, in FIGS. 4 and 5, the same XYZ orthogonal coordinate system is set.

In the battery manufacturing apparatus 100 illustrated in FIG. 4, a resinous protection sheet S1 is conveyed on a top surface 109 of a table-like original sheet support portion 101 by rollers 104 and 105. An original sheet S2 for the electrode plates is conveyed on the protection sheet S1 conveyed on the top surface 109 by rollers 103 and 106. Here, the direction for conveying the original sheet S2 is the same as the direction for conveying the protection sheet S1, that is, the X direction. The original sheet S2 includes a formation area A2, where a negative electrode active material or a positive electrode active material is coated on a current collector for the positive electrode or for the negative electrode, and a non-formation area A1, where the negative electrode active material or the positive electrode active material is not coated on the current collector.

Further, a driving section 107 is arranged in the battery manufacturing apparatus 100. The driving section 107 holds the mold 102 (to be described later) facing the top surface 109 of the original sheet support portion 101. As illustrated in FIG. 5, for example, two Thomson blades are arranged on the mold 102. The shape of each Thomson blade corresponds to the outer shape of the electrode plate described above. The corresponding portions of the two Thomson blades to the electrode tabs face in opposite directions along the Y direction, which is perpendicular to the direction for conveying the original sheet S2. More specifically, the mold 102 has a shape as illustrated in FIG. 5. That is, the mold 102 includes a first blade 111 that is fixed onto a base substrate 110, a second blade 112, and a pressing member 113 such as a sponge arranged around the blades.

The first blade 111 and the second blade 112 have the same shape, and are line-symmetrical to each other with respect to an imaginary line, which passes through the center of the original sheet S2 in the width direction (i.e., the Y direction) and which is parallel to the direction for conveying the original sheet S2 (i.e., the X direction). The pressing member 113 protrudes from the first blade 111 and the second blade 112 in the direction (i.e., the Z direction) perpendicular to the surface of the base substrate 110.

The driving section 107 may move the mold 102 up to the +Z direction and down to the +Z direction.

Furthermore, a control section 108 is arranged in the battery manufacturing apparatus 100, and the control section 108 controls the operation of the rollers 103 to 106 and the driving section 107. Specifically, the battery manufacturing apparatus 100 is operated as below.

The control section 108 controls the rollers 103 to 106 to intermittently convey the original sheet S2 and the protection sheet S1 on the top surface 109 of the original sheet support portion 101. That is, the original sheet S2 and the protection sheet S1 are simultaneously conveyed at the same speed, and are stopped after they are conveyed by the predetermined distance. After the original sheet S2 and the protection sheet S1 are stopped, the control section 108 drives the driving section 107. In the movement of the driving section 107, the mold 102 moves down toward the original sheet S2 to the −Z direction, and the electrode plate is punched out from the original sheet S2. After the electrode plate is punched out, the mold 102 moves up to the +Z direction and returns to the initial position. At this time, the electrode plate punched out and the other portions of the original sheet S2 are still remained on the same plane, that is, on the top surface 109.

The amount of the movement of the mold 102 is controlled by the control section 108 in order that the mold 102 reliably contacts the original sheet S2 and that the mold 102 does not contact the original sheet support portion 101 by passing through the protection sheet S1. Therefore, damages of the original sheet support portion 101 and the mold 102, caused by contacting each other, are prevented. Further, the non-formation area A1 is used to form the positive electrode tab or the negative electrode tab, and the formation area A2 is used to form the positive electrode body or the negative electrode body.

Subsequently, the control section 108 controls the rollers 103 to 106 again to intermittently convey the original sheet S2 and the protection sheet S1 on the top surface 109 of the original sheet support portion 101. The electrode plate punched out is absorbed by an arm 130 at a position where it is stopped for the first time, after being punched out and then being conveyed. Then, The electrode plate is conveyed to a table (not illustrated) by the arm and stacked on a table. Therefore, only the original sheet S2, having a hole corresponding to the shape of the electrode plate punched out, is sequentially and intermittently conveyed toward a box (not illustrated) prepared in the direction for conveying the original sheet S2 in the battery manufacturing apparatus 100, and is collected as trash in the box.

Incidentally, generally, when a circular through-hole is formed in an electrode tab by a conventional battery manufacturing apparatus that does not form the slit in the electrode tab, it is needed that a circular blade for forming the circular shape is prepared to a mold used in the battery manufacturing apparatus, or that a through-hole is formed in the electrode tab after an electrode plate is conveyed to the outside of the conventional battery manufacturing apparatus by an arm.

However, in a case that the circular blade is prepared to the mold, a portion of the original sheet S2 corresponding to the through-hole as a waste, flys or moves to an unexpected place. Therefore, for example, when the waste is put on the electrode plate, the waste is conveyed by the arm and assembled to the battery. As a result, there is a possibility that the performance of the battery may be abnormal.

Further, in a case that the through-hole is formed in the electrode tab after the electrode plate is conveyed to the outside of the conventional battery manufacturing apparatus, the number of processes increases. As a result, there is a possibility that the productivity of the battery becomes degraded.

In contrast, in the battery manufacturing apparatus 100 described above, although the through-hole is formed in the electrode tab of the electrode plate, the portion corresponding to the through-hole in the original sheet S2 is not separated from the original sheet S2, and is still a part of the original sheet S2 having a hole corresponding to the shape of the electrode plate. This is because the through-hole regarding the embodiment is formed to include the slit as well as the through-hole body.

Accordingly, there are the above-described other advantages that abnormality of the battery is reduced and that the productivity is improved, as compared with the conventional battery manufacturing apparatus.

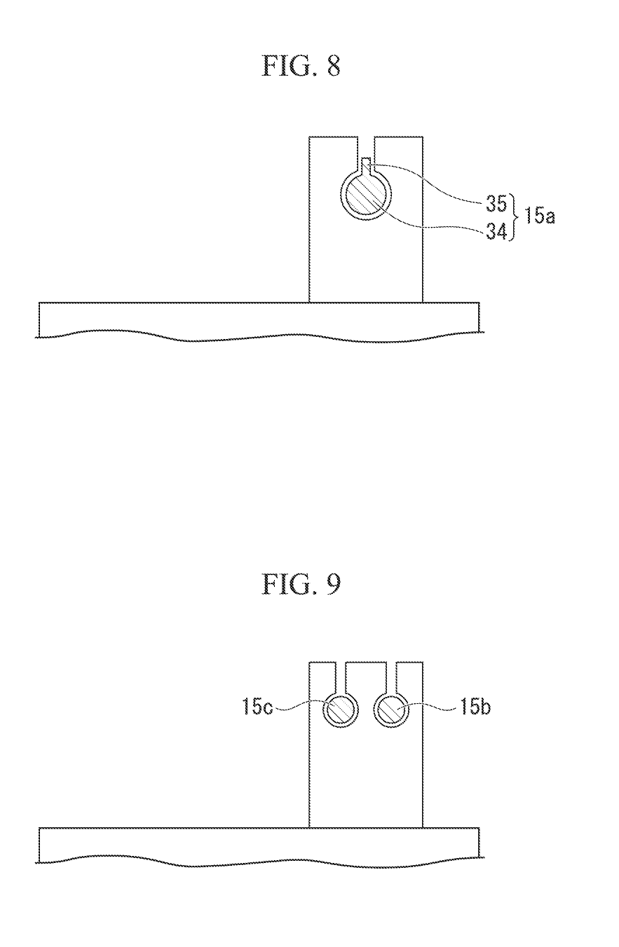

Although the cross-sectional shape of the fastening member of the electrode terminal on the XY plane in the first embodiment is the substantially circular shape, the shape may be formed in a key shape as illustrated in FIG. 8. A fastening member 15a in this case includes an axial rod 34 and a protrusion 35, which is formed with the axial rod as one body and which protrudes from the axial rod. When the protrusion 35 is arranged at the slit of the electrode tab, the rotation of the electrode plate is prevented by the protrusion 35 of the fastening member 15a, even in a case that vibration or the like is applied to the battery 1. Therefore, because it is possible to prevent a variation of relative positions between the positive electrode plates and the negative electrode plates in the stacked electrode body, the battery 1 of good performance is provided.

Of course, when the rotation may be prevented, the same advantage is obtained. Therefore, the shape of the fastening member is not needed to be the key shape. For example, a plurality of fastening members extending from the electrode terminal may be formed, instead of one as in the first embodiment. In this case, a plurality of through-hole bodies in the electrode tab is formed as corresponding to each of the fastening members respectively. Even in this case, the outer shape of the electrode plate arranged on the YZ plane is a shape which is drawn at one time together with including the through-hole body and the slit. In FIG. 9, as a specific example, two fastening members 15b and 15c having a substantially circular cross-sectional shape on the XY plane formed in each electrode terminal are illustrated. Because the electrode tab is fixed by the two fastening members, the rotation may be prevented.

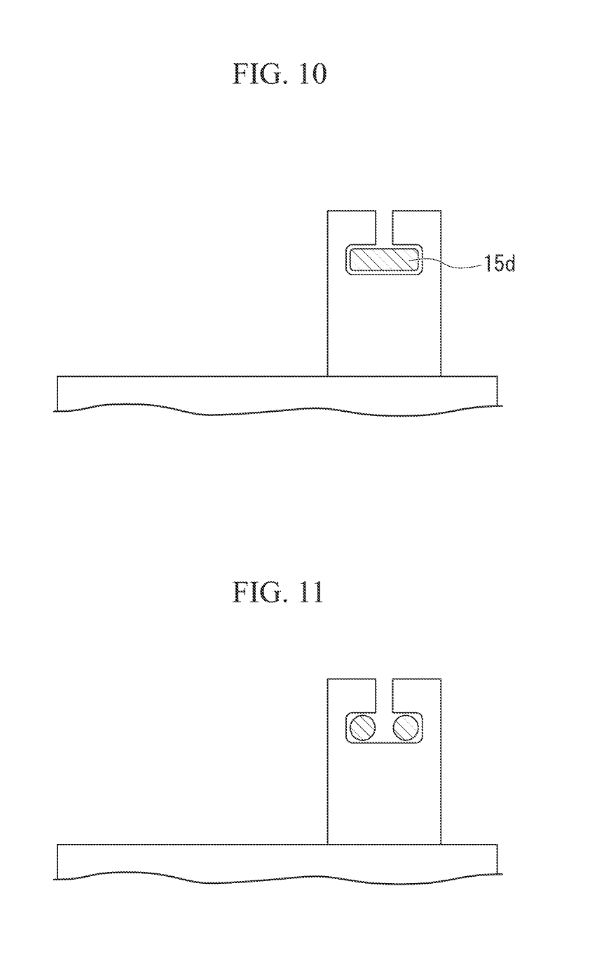

As a structure for preventing the rotation, the cross-sectional shape of the fastening member of the electrode terminal on the XY plane may be formed in a substantially rectangular shape as illustrated in FIG. 10, instead of a circular shape. In this case, the through-hole body of the electrode tab may be formed in substantially the same shape as the above-described shape (i.e., the substantially rectangular shape). Because the cross-sectional shape of the fastening member 15d is a substantially rectangular shape, the rotation may be also prevented. Of course, in this case, the single fastening member having the substantially rectangular cross-sectional shape may be substituted by the plurality of fastening members as illustrated in FIG. 11.

Furthermore, when the outer shape of the electrode plate arranged on the YZ plane is a shape drawn at one time with including the through-hole body and the slit and is able to be drawn with a single stroke although the through-hole body and the slit are drawn together, the cross-sectional shape of the fastening member on the XY plane may be formed in, for example, a triangular shape or a star shape, instead of the circular shape or the rectangular shape. In this case, the shape of the through-hole body of the electrode tab may be formed in substantially the same shape as the cross-sectional shape. Even in this case, the rotation is prevented, and the battery 1 of good performance is provided.

Although it is not mentioned in the description above, the structures of FIGS. 8 to 11 may be applied to the positive electrode terminal, the positive electrode tab corresponding to the positive electrode terminal, the negative electrode terminal, and the negative electrode tab corresponding to the negative electrode terminal.

### Second Embodiment

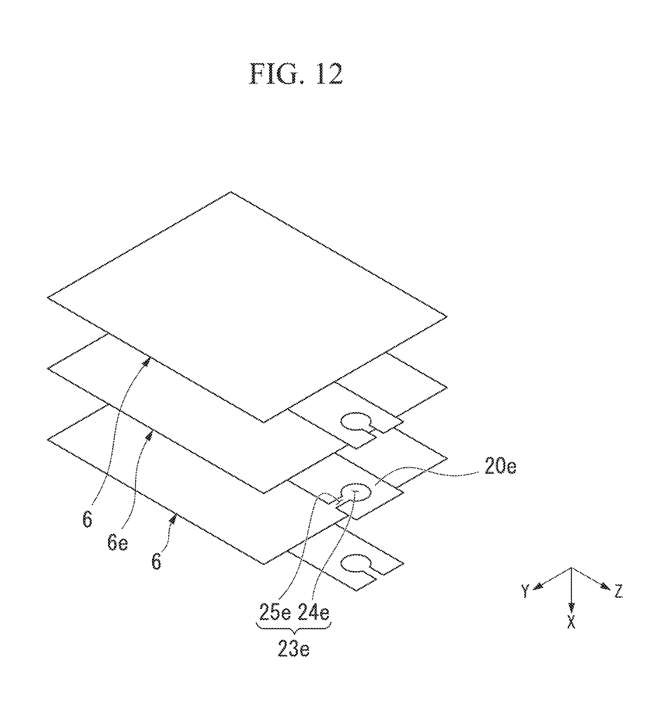

Next, a battery of a second embodiment will be described by referring to FIG. 12. As to a plurality of positive electrode plates sequentially staked in a stacked electrode body, the embodiment is different from the first embodiment at a point that there are at least two types of positive electrode plates, one of which is a first positive electrode plate having a slit formed in the Z direction as in FIG. 3 in a positive electrode tab and the other of which is a second positive electrode plate having a slit formed in a direction different from that of the first positive electrode plate (e.g., the Y direction) in a positive electrode tab. Because the other structures are the same as those of the battery 1 regarding the first embodiment, the description thereof will not be repeated.

In FIG. 12, a structure is illustrated, in which there are the positive electrode plates 6 and a positive electrode plate 6e having a slit of which the direction is different from that of the positive electrode plate 6 illustrated in FIG. 3. The positive electrode plate 6e is the same as the positive electrode plate 6 except for the slit. And the positive electrode plates 6 and a positive electrode plate 6e are alternately stacked. Separators and negative electrode plates are not illustrated in FIG. 12, although they are arranged appropriately for forming a stacked electrode body. The positive electrode plate 6e has a through-hole including a through-hole body 24e having the same shape as that of the through-hole body 24, and a slit 25e formed in the Y direction, which is continuous from the outside of the positive electrode plate 6e to the through-hole body 24e.

Accordingly, because different slits are respectively formed in one of the positive electrode plate and the adjacent positive electrode plate stacked on the one, that is, the slits of the adjacent positive electrode plates do not overlap each other or do not overlap completely, while the positive electrode plates are stacked, it is possible to obtain an advantage that the stacked electrode body is prevented from being separated from the rivet of the positive electrode terminal (i.e., the separation of the stacked electrode body), in addition to the advantages described in the first embodiment.

Here, the positive electrode plate has been mentioned, but the negative electrode plate may have the same structure. Further, between the positive electrode plate and the negative electrode plate, either one may has the shape of the electrode tab illustrated in the embodiments, or both electrode plates may have the shape of the electrode tab illustrated in the embodiments.

In the above-described embodiments, the lithium ion secondary battery has been exemplified, but the invention is not limited thereto. The invention may be applied to a secondary battery or a primary battery using other active materials as long as the battery uses the stacked electrode body. For example, the invention may be applied to a sodium battery such as a sodium-sulfur battery or a nickel battery such as a nickel hydride battery. The invention may be applied to a winding-type battery in addition to a stacked-type battery within the spirit of the invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A battery comprising:
an electrode terminal including a fastening member; and
an electrode plate including an electrode tab having a through-hole,
wherein the through-hole is a part of an outer shape of the electrode plate, and the electrode terminal and the electrode plate are electrically connected through the through-hole by the fastening member.

2. The battery according to claim 1,
wherein the through-hole includes:
a through-hole body passing through the electrode tab from a front side of the electrode tab to a rear side of the electrode tab, and
a slit passing through the electrode tab from a front side of the electrode tab to a rear side of the electrode tab, and being continuous from an outside of the electrode plate to the through-hole body.

3. The battery according to claim 2,
wherein maximum width of the through-hole body is larger than maximum width of the slit.

4. The battery according to claim 3,
wherein a cross-sectional shape of the fastening member is different from a circular shape, and a shape of the through-hole body is substantially the same as the cross-sectional shape.

5. The battery according to claim 4,
wherein the fastening member is a rivet.

6. A battery manufacturing apparatus for forming the battery according to claim 1, the battery manufacturing apparatus comprising:
a mold for cutting the electrode plate; and
a driving section driving the mold,
wherein the driving section drives the mold to cut the electrode plate from an original sheet.

7. A battery comprising:
an electrode terminal including a fastening member;
a first electrode plate including a first electrode tab having a first through-hole; and
a second electrode plate including a second electrode tab having a second through-hole,
wherein the first through-hole includes:
a first through-hole body passing through the first electrode tab from a front side of the first electrode tab to a rear side of the first electrode tab, and
a first slit passing through the first electrode tab from a front side of the first electrode tab to a rear side of the first electrode tab, and being continuous from an outside of the first electrode plate to the first through-hole body,
wherein the second through-hole includes:
a second through-hole body passing through the second electrode tab from a front side of the second electrode tab to a rear side of the second electrode tab and having substantially the same shape as that of the first through-hole body, and
a second slit passing through the second electrode tab from a front side of the second electrode tab to a rear side of the second electrode tab, and being continuous from an outside of the second electrode plate to the second through-hole body, and
wherein the electrode terminal and the first and the second electrode plates are fixed and electrically connected to each other through the first and the second through-holes by the fastening member.

8. The battery according to claim 7,
wherein the first slit and the second slit do not overlap completely when the first and the second electrode plates are fixed by the fastening member.

9. A battery manufacturing apparatus for forming a battery comprising:
a mold for cutting an electrode plate including an electrode tab having a through-hole; and
a driving section driving the mold,
wherein the driving section drives the mold to cut the electrode plate from an original sheet, and wherein the through-hole is a part of an outer shape of the electrode plate.

10. The battery manufacturing apparatus according to claim 9,
wherein the through-hole includes:
a through-hole body passing through the electrode tab from a front side of the electrode tab to a rear side of the electrode tab, and
a slit passing through the electrode tab from a front side of the electrode tab to a rear side of the electrode tab, and being continuous from an outside of the electrode plate to the through-hole body.

11. The battery manufacturing apparatus according to claim 10,
wherein maximum width of the through-hole body is larger than maximum width of the slit.

12. The battery according to claim 8,
wherein the first through-hole includes:
a first through-hole body passing through the first electrode tab from a front side of the first electrode tab to a rear side of the first electrode tab,
a first slit passing through the first electrode tab from a front side of the first electrode tab to a rear side of the first electrode tab, and being continuous from an outside of the first electrode plate to the first through-hole body,
a second through-hole body passing through the second electrode tab from a front side of the second electrode tab to a rear side of the second electrode tab, and
a second slit passing through the second electrode tab from a front side of the second electrode tab to a rear side of the second electrode tab, and being continuous from an outside of the second electrode plate to the second through-hole body.

13. The battery according to claim 12,
wherein the first through-hole is a part of an outer shape of the first electrode plate and the outer shape is able to be drawn with a single stroke with including the first through-hole body and the first slit, and
wherein the second through-hole is a part of an outer shape of the second electrode plate and the outer shape is able to be drawn with a single stroke with including the second through-hole body and the second slit.

14. The battery according to claim 13,
wherein maximum width of the first through-hole body is larger than maximum width of the first slit, and
wherein maximum width of the second through-hole body is larger than maximum width of the second slit.

15. The battery according to claim 14,
wherein a cross-sectional shape of the fastening member is different from a circular shape, and shapes of the first through-hole body and the second through-hole body are substantially the same as the cross-sectional shape.

16. The battery according to claim 15,
wherein the fastening member is a rivet.

17. The battery according to claim 1
wherein the outer shape is able to be drawn with a single stroke with including the through-hole body and the slit.

18. The battery according to claim 2,
wherein the outer shape is able to be drawn with a single stroke with including the through-hole body and the slit.

19. The battery according to claim 3,
wherein the outer shape is able to be drawn with a single stroke with including the through-hole body and the slit.

20. The battery according to claim 4,
wherein the outer shape is able to be drawn with a single stroke with including the through-hole body and the slit.

21. The battery manufacturing apparatus according to claim 11,
wherein the outer shape is able to be drawn with a single stroke with including the through-hole body and the slit.
